(19) United States
(12) Patent Application Publication
(10) Pub. No.: US 2014/0334262 A1
(43) Pub. Date: Nov. 13, 2014

(54) Method and Apparatus for Active Seismic Shear Wave Monitoring of Hydro-Fracturing of Oil and Gas Reservoirs Using Arrays of Multi-Component Sensors and Controlled Seismic Sources

(71) Applicant: Robert H. Brune, Evergreen, CO (US)

(72) Inventor: Robert H. Brune, Evergreen, CO (US)

(21) Appl. No.: 14/258,396

(22) Filed: Apr. 22, 2014

Related U.S. Application Data
(60) Provisional application No. 61/814,611, filed on Apr. 22, 2013.

(51) Int. Cl. G01V 1/50

(52) U.S. Cl. CPC G01V 1/50
USPC 367/86

(57) ABSTRACT

Disclosed herein are various embodiments of a technique to monitor hydro-fracturing in oil and gas wells by use of active seismic sources and arrays of monitoring sensors. The invention utilizes combinations of seismic sources such as vertical vibrators in anti-phase pairs. The invention utilizes combinations of multi-component rotational seismic sensors, and/or multi-component linear sensors, and/or pressure sensors. Sensors are jointly deployed in arrays on the surface and/or in shallow monitoring wells to avoid the complicating effects of the free surface of the earth. The emplacement of sensors on the surface or in the shallow monitoring wells may be permanent. Fractures are monitored by combinations of physical effects such as propagation time delays, shear reflections, birefringent shear wave splitting, and amplitude variations. The method has a wide range of application in oil and gas exploration and production. This abstract is not intended to be used to interpret or limit the claims of this invention.

### CROSS-REFERENCE TO RELATED APPLICATIONS

This application claims the benefit under 35 USC §119 (e) of U.S. Provisional Patent Application No. 61/814,611 filed on Apr. 22, 2013, the disclosure of which is incorporated herein by reference.

### FIELD

Various embodiments described herein relate to the field of seismic data acquisition and processing, and devices, systems and methods associated therewith.

### BACKGROUND

Fracture Statistics/Characterization

It has been long appreciated that there are complexities in measuring and describing statistical characteristics of fracturing in rocks, such as fracture porosity, fracture intensity, fracture density, etc. See, for example, “A multi-dimensional system of fracture abundance measures”, Mauldon and Dershowitz, Geological Soc. of America annual meeting, 2000.

Passive Micro-Seismic

There is a long term trend of increasing passive seismic monitoring in and around oil and gas fields. For a summary of early developments, see for example “Advanced fracture methods and mapping”, Weijers, Soc. Petroleum Engineers Training Course, 2005, and “Active and passive imaging of hydraulic fractures”, Wills, The Leading Edge, July, 1992. More recently, there is widespread commercial availability of passive seismic monitoring services.

The recording of passive seismic data on the surface of the earth, in arrays of shallow wells, and in deep boreholes is now common practice in the oil and gas industry. In monitoring the hydrofracturing of oil and gas reservoirs, it is often useful to be able to discriminate between compressional and shear waves.

Techniques such as described in U.S. Pat. No. 5,774,419 to Uhl et al., entitled “High Speed Point Derivative Microseismic Detector”, to are used to distinguish seismic arrival events from background noise. Techniques such as described in U.S. Pat. No. 7,663,970 to Duncan et al. entitled “Method for Passive Seismic Emission Tomography” are employed to locate seismic source events. Techniques such as described in U.S. Pat. No. 7,660,194 to Uhl et al. entitled “Microseismic Fracture Mapping Using Seismic Source Timing Measurements for Velocity Calibration” are used to refine the seismic velocity field to enhance the location of seismic source events. Techniques such as described in U.S. Pat. No. 7,590,491 to Saenger entitled “Signal Integration Measure for Seismic Data” are used to passively monitor production of fluids from reservoirs.

3D and Time Lapse 4D Seismic Surveys

Techniques for 3D and 4D seismic surveys of oil and gas fields using arrays of sensors and active seismic sources deployed on the surface are well established in commercial practice. Such surveys typically utilize compressional body waves, but may sometimes utilize converted waves or shear waves. Persons having ordinary skill in the art will understand that changes in reflection amplitude due to changes in fracture density are generally relatively insensitive for compressional body waves, compared to shear body waves. It will also be understood that the change in interval velocity due to changes in fracture density in a target zone will be generally less sensitive for compressional body waves, compared to shear waves. Persons having ordinary skill in the art will understand that the use of conventional time-lapse 4D survey geometries to monitor Stimulated Rock Volumes (SRV) in near-real-time during a hydrofracturing operation is relatively impractical compared to conventional micro-seismic passive monitoring.

Permanent Reservoir Monitoring (PRM)

In recent practice, permanent deployments of 3-Component linear sensors and/or pressure sensors in arrays of shallow monitoring wells have become a common commercial practice over selected oil and gas fields. These deployments are used for active monitoring in combination with active seismic sources; and for passive monitoring to detect natural seismic events that may in turn be due to movement of fluids, hydrofracturing, or the like.

Shear Wave Shadowing by Fractures

Techniques such as “shear wave shadowing” have been attempted to map fractures in the subsurface. In this technique, active seismic sources on the surface are recorded in deep well(s) and data are analyzed to try to detect locations and orientations where shear waves did not propagate across fractures of particular orientation. See, for example, PCT Application WO 99/04292 to Winterstein et al., entitled “Method for Monitoring an Induced Fracture with VSP”, and “9-C time-lapse VSP monitoring of steam injection at Cymric oil field”, Winterstein, The Leading Edge, April, 1998.

Converted Waves (C-Waves)

Techniques have been devised to attempt to separate compressional and shear waves in the processing of multi-component linear motion data. These include many various well established seismic signal and image processing techniques, as well as wave propagation based processing, such as, for example, that described in “Separating P- and S-waves in prestack 3D elastic seismograms using divergence and curl”, Sun, et. al., Geophysics, Vol. 69, No. 1, p 286-297, 2004. Separation of compressional and shear waves was described in U.S. Pat. No. 2,657,373 to Piety entitled “Apparatus for Seismic Exploration”, which utilizes horizontal phase velocity as an input parameter.

Six Degrees-of-Freedom (6-DOF)

It is well understood in many fields of physical science and engineering that a complete representation of mechanical motion requires the measurement of six degrees-of-freedom. Typically this is accomplished by measuring three orthogonal linear motions, and measuring rotations around three orthogonal axes.

3-Component Linear (3-C)

There is much well established technology for measurement of the linear particle motion of seismic wavefields in the earth. Many commercial sensors exist to measure particle velocity or particle acceleration along one, or up to three, linear axes, utilizing various physical concepts to accomplish the measurements. It is most common to utilize measurements of the vertical particle motion.

3-Theta Rotational (3-θ)

There is an evolving commercial technology for measurement of the rotational particle motion of seismic wavefields in the earth. Early technology is represented by, for example, U.S. Pat. No. 3,407,305 to Sterry entitled “Optical Rotational Seismometer” and U.S. Pat. No. 4,603,407 to Cowles entitled “Rotational Geophone”. Newer technology is represented by, for example, sensors such as those commercially offered by MetTech (model Metr-3) and Entec (models R-1 and R-2). U.S. Pat. No. 7,516,660 describes MetTech sensor technology. See also Entec R-1_data_new.pdf provided as a reference to this application. U.S. Pat. No. 7,474,591 to Menard et al., entitled “Six-Component Seismic Data Acquisition System” describes technology to measure rotational data from differences of linear data.

Seismic rotational motion is commonly understood to be the vector curl of the infinitesimal displacement field. The existing rotational sensors are understood to measure the components of this vector curl.

The utility of rotational seismic measurements is appreciated in earthquake and regional crustal seismology, as discussed, for example, in “Rotational Seismology and Engineering Applications”, Lee, W., et al., eds., Bull. Seismological Society of America, vol. 99, no. 2B, supplement, May 2009.

Free Surface

It is well understood that the free surface of the earth often adds a significant complicating effect to the separation of compressional waves from shear waves. This is largely due to conversion between compressional and shear waves at the free surface. However, it is also known that these conversions do not have a big effect for the particular case of wave propagation in a near vertical direction, generally perpendicular to the earth's surface.

Elastic Waves

Elastic seismic wave theory is well understood, particularly for a linear homogeneous isotropic earth. The surface of the earth is approximately a stress free surface. The effect of the free surface on elastic waves is well understood, as described in technical references such as “Quantitative Seismology”, Aki and Richards, University Science Books, 2002 or “An Introduction to Seismology, Earthquakes, and Earth Structures”, Stein S. and Wysession, M., Blackwell Publishing, (2003).

Active Source Micro-Seismic Monitoring

It is well known that induced fractures will affect the amplitude and velocity of seismic waves transmitted from an active source. See, for example “Numerical and experimental study of hydraulic fracture active source monitoring”, Nabipour, A., et. al., presented at EAGE, Vienna, May 2011.

Various techniques to utilize an active seismic source for fracture monitoring are disclosed in U.S. Pat. No. 7,967,069 to Beasley entitled “Active Seismic Monitoring of Fracturing Operations”; U.S. Pat. No. 8,210,262 to Beasley entitled “Active Seismic Monitoring of Fracturing Operations” and in U.S. Patent Application 2013/0000893 A1 to Beasley entitled “Active Seismic Monitoring of Fracturing Operations”. Note that these techniques utilize images of the subsurface as in 4D seismic surveys, rather than specialized attributes. These technologies are not intended for near-real-time usage. These technologies do not utilize specially selected sensitive attributes such as Shear Wave Splitting, nor utilize specially selected measurement equipment such as rotational seismic sensors. Some of these technologies rely on additives being deployed in hydro-fracturing fluids. Some of these technologies are focused on mapping locations of fracturing fluids, rather than measuring rock property changes due to fracturing.

Another active source technique for hydraulic fracture monitoring is disclosed in WO 2102/173924 A2 to Wills entitled “Hydraulic Fracture Monitoring Using Active Seismic Sensors with Receivers in the Treatment Well”. Note that this application discloses a technique utilizing seismic receivers downhole in a well being hydro fractured, with a seismic source on the surface.

Amplitude Vs. Offset (AVO) and Amplitude Vs. Azimuth (AVA)

It is widely recognized by those with skill in the art that Amplitude Variations vs. Offset or reflection angle (AVO), and particularly Amplitude Variations vs. Azimuth (AVA) are often an incisive seismic indicator of fracture orientation and density. See, for example “Reflection coefficients and azimuthal AVO analysis in anisotropic media”, Ruger, A., SEG Geophysical Monograph Series No. 10, 2001. See also “Correlation between P-wave AVOA and S-wave traveltime anisotropy in a naturally fractured gas reservoir: Lynn, H., et al., The Leading Edge, Vol. 8, p 931-935, 1996. See also U.S. Pat. No. 5,999,486 to DeVault entitled “Method for Fracture Detection Using Multicomponent Seismic Data” which discloses techniques to use AVO to detect fractures.

Additional known amplitude techniques for fracture analysis include those described in “Spatial orientation and distribution of reservoir fractures from scattered seismic energy”, Willis, abstract, SEG annual meeting, 2004, wherein wavelet codas are analyzed for situations where fracture spacing is ‘tuned’ to fracture spacing.

Persons having ordinary skill in the art will recognize that deploying the field geometries to acquire AVO or AVA field data that is focused on a target Stimulated Rock Volume in a hydro-fracturing operation will require spatially extensive seismic sources and or receivers. Such a deployment further requires careful attention to placement so as to not miss the target zone.

Vertical Seismic Profiling (VSP) & Time-Lapse

The use of shear wave Vertical Seismic Profiles (VSP's) for fracture detection and analysis has long been known. See, for example, “Shear-wave VSP's: a powerful new tool for fracture and reservoir description”, Crampin, S., et al., Journal of Petroleum Tech., March 1989, p 283-289. See also Mazumdar, P., et al., “Shear-wave sourced 3-D VSP image interpretation of tight gas sandstones in Rulison field, Colorado”, CSEG Recorder, June 2010, p 28-33. The use of VSP geometries for time-lapse changes in reservoirs has also been long recognized. See, for example, O'Brien, J., et al., “Time-lapse VSP reservoir monitoring”, The Leading Edge, 2004, p 1178-1184. See also “Hydraulic fracture quality from time lapse VSP and microseismic data: Willis, M., et al., presented at SEG Annual Meeting, 2008.

Persons having ordinary skill in the art will recognize that VSP style geometries with near vertical travel paths offer some significant simplifications in the analysis of seismic data compared to other geometries often employed in 3D and 4D; and also compared to downhole micro-seismic monitoring in offset monitoring wells.

Shear Wave Splitting

The nature of Shear Wave Splitting has been long recognized. See, for example, “Shear-wave splitting: Tutorial, issues and implications for 9-C 3-D seismic reflection data”, Simmons, J. and M. Backus, abstract, 1999 SEG annual meeting. Shear Wave Splitting has long been recognized in association with fracturing. See, for example, “VSP detection of fracture-induced velocity anisotropy”, Johnston, D., abstract, 1986 SEG annual meeting. Elastic wave analysis of Shear Wave Splitting (SWS; birefringence) due to sets of vertical fractures in the presence of Vertical Transverse Isotropy, such as due to layering, has been advocated for complete analysis of fracturing in reservoirs. The effect of multiple sets of fractures with different azimuths is recognized as being significant.

Techniques for the use of passive micro-seismic data are well documented. See, for example “Detection of multiple fracture sets using observations of shear-wave splitting in microseismic data”, Verdon, J. and J-M. Kendall, Geophysical Prospecting, 2011, Vol. 59, 593-608. Note that this analysis employed no active seismic source, used only downhole monitoring data, did not utilize rotational seismic data or analysis, and did not undertake any near-real-time analysis of fracturing both immediately before and immediately after fracturing a given Stimulated Rock Volume.

See also “Twelve years of vertical birefringence in nine-component VSP data” Winterstein, D., et. al., 2001, Geophysics, 2001, Vol. 66, p 582-597, which summarizes Shear Wave Splitting results from a number of VSP surveys.

See also “Stress-induced temporal variations in seismic anisotropy observed in microseismic data”, Teanby, N., et. al., Geophysical Journal Intl., 2004, Vol. 156, p 459-466 which describes temporal changes in Shear Wave Splitting due to stress changes.

It has long been recognized that the amount of delta-t Shear Wave Splitting due to fracturing within target oil and gas reservoirs is significant and is readily detectable in practice. For example, in “Shear-wave birefringence: a new tool for evaluating fractured reservoirs”, Martin, M. and Davis, T., The Leading Edge, 1987, p 22-28, FIG. 11 shows SWS delta-t's with magnitudes of 10 to 15 msec. in the Niobrara shale; and “Error in shear-wave polarization and time splitting”, Michaud, G., and Snieder, R., Geophysical Prospecting, 2004, Vol. 52, p 123-132 shows 10 msec. of delta-t within a reservoir interval. In the context of time-lapse downhole VSP seismic data. “Fracture detection using crosshole surveys and reverse vertical seismic profiles at the Conoco Borehole Test Facility, Oklahoma”, Liu, E., et. al, Geophysical Journal Intl., 1991, Vol. 107, p 449-463 notes 7 msec. of Shear Wave Splitting in a relatively thin, shallow lithologic unit.

It is recognized that in conjunction with the velocity/time differentials due to Shear Wave Splitting, there also will typically be attenuation differences between fast and slow shear waves. See “Amplitude effects associated with shear-wave splitting”, Gratacos, B., et. al., abstract, 2009 SEG annual meeting. These attenuation differences lead to changes in wavelet shapes, frequency content, and add additional differential phase/time delays.

SWS Rotation/Processing

Analytical techniques to process Shear Wave Splitting data in VSP type geometries are also well known. Numerical rotation of source polarizations and/or sensor polarization is well known. See, for example, “Shear data in the presence of azimuthal anisotropy”, Alford, R. M., abstract, 1986 SEG annual meeting. See also “A new algorithm for the rotation of horizontal components of shear-wave seismic data”, Fang, K. and R. J. Brown, CREWES Research Report, 1996, vol. 8. See further “Algebraic processing techniques for estimating shear-wave splitting in near-offset VSP data”, Zeng, X., and C. Macbeth, Geophysical Prospecting, 1993, Vol. 41, p 1033-1066. “Fractured reservoir characterization using shear-wave splitting in MicroSeismic data: a case study from Oman”, Al-Harrasi, 2010, PhD Thesis, U. of Bristol, UK, discusses detailed analysis of Shear Wave Splitting in micro-seismic data in the Oman.

In many seismic acquisition geometries there is a need to analyze Shear Wave Splitting data so as to determine where in a total travel path the splitting occurred. Various layer stripping technologies have been developed, including, for example, European Patent Application EP 0 463 604 B1 to Winterstein entitled “Method of Layer Stripping to determine fault plane stress build-up”. See also U.S. Pat. No. 6,862,531 to Horne, entitled “Layer stripping converted reflected waveforms for dipping fractures”, and WO Patent Application 2012/154295 A1 to Bansal, et al., entitled “True-amplitude layer stripping in fractured media”.

Vibrator Shear Wave Source

Vibrator seismic sources specifically designed to generate SH mode seismic energy have been commercially offered in the past. Persons having ordinary skill in the art will also recognize that it is possible to generate vertically downgoing shear body waves by utilizing a pair of vertical seismic vibrators in a dipole type arrangement. See, for example, U.S. Pat. No. 4,286,332 to Edelmann entitled “Method and apparatus for producing shear waves for subsurface geophysical investigation”. See also “On the partition of energy between elastic waves in a semi-infinite solid”, Miller, G. F. and H. Pursey, Proc. Royal Soc. London, 1955, A 233-234, 55-69. See further “The elastodynamic field of N interacting vibrators” Tan, T. H., Geophysics, 1985, No. 8, p 1229-1252. It is also well recognized that individual vertical vibrators emit significant amount of shear body wave energy at angles off the vertical axis.

There remains a need for an active source fracture monitoring technology, particularly for those many areas where passive monitoring is not effective due to weak signals at the surface and/or poor positioning of available monitoring wells. There is a need for a technology that is logistically practical without requiring large scale activity such as a conventional 4D survey. There is a need for spatially focused measurements on the scale of VSP measurements. There is a need to incorporate surface sources and/or receivers so as to ameliorate the requirements for ideally-positioned monitoring wells. There is a need for measurements of seismic parameters that are sensitive to fracture density, such as birefringence time splitting. There is a need for techniques that are amenable to near real-time operations so as to be useful in managing the individual stages of hydro-fracturing operations.

### SUMMARY

In one embodiment there is provided a method for detecting fractures in near real-time during the pumping of a hydrofracture operation in an oil and gas reservoir, comprising: repeatedly emitting seismic shear waves in a generally downward direction in two or more polarizations, at one or more locations on the surface of the earth; recording data reflected from below an array of seismic sensors and analyzing the recorded data to detect fast and slow shear waves at the seismic sensors, to detect changes in the seismic arrival times during the general duration of the hydrofracture operations, or longer, so as to detect changes in fracturing within the Stimulated Rock Volume of the oil and gas reservoir.

In another embodiment there is provided an apparatus for detecting fractures in near real-time during the pumping of a hydrofracture operation in an oil and gas reservoir, comprising: an apparatus to emit seismic shear waves in a generally downward direction in two or more polarizations, at one or more locations on the surface of the earth; an apparatus to measure and record data reflected from below an array of seismic sensors, and an apparatus to analyze the recorded data to detect fast and slow shear waves at the seismic sensors, and to detect changes in the seismic arrival times during the general duration of the hydrofracture operations or longer so as to detect changes in fracturing within the Stimulated Rock Volume of the oil and gas reservoir.

In yet another embodiment there is provided a geophysical system to detect changes in fractures in near real-time during the pumping of a hydrofracture operation in a potential oil and gas reservoir, comprising: a sub-system to repeatedly emit seismic shear waves in a generally downward direction in two or more polarizations, in one or more locations on the surface of the earth; a sub-system of multi-component linear sensors, multi-component rotational sensors, or both multi-component linear sensors and multi-component rotational sensors, and a system to record data reflected from below the array of seismic sensors and a sub-system to analyze the recorded data to detect fast and slow shear waves at the seismic sensors, and to detect changes in the seismic arrival times during the general duration of the hydrofracture operations, or longer, so as to detect changes in fracture density within the Stimulated Rock Volume of the oil and gas reservoir.

Further embodiments are disclosed herein or will become apparent to those skilled in the art after having read and understood the specification and drawings hereof.

### BRIEF DESCRIPTION OF THE DRAWINGS

Different aspects of the various embodiments of the invention will become apparent from the following specification, drawings and claims in which:

FIG. 1 illustrates the overall field deployment of the method and apparatus;

FIG. 2 illustrates the overall wave propagation configuration with reference to polarizations of source and receivers;

FIG. 3A depicts in map view an example of the deployment of vertical seismic vibrator sources;

FIG. 3B depicts the orientation and sign conventions in one exemplary configuration for each of the sensor locations;

FIG. 3C diagrammatically depicts Shear Wave Splitting at one sensor location;

FIG. 4 illustrates some seismic wave travel paths;

FIG. 5A is an example of a map view of a target stimulated rock volume and

FIG. 5B is an example of a display of one of many possible alternate datasets.

The drawings are not necessarily to scale. Like numbers refer to like parts or steps throughout the drawings.

### DETAILED DESCRIPTIONS OF SOME EMBODIMENTS

In the following description, specific details are provided to impart a thorough understanding of the various embodiments of the invention. Upon having read and understood the specification, claims and drawings hereof, however, those skilled in the art will understand that some embodiments of the invention may be practiced without hewing to some of the specific details set forth herein. Moreover, to avoid obscuring the invention, some well-known methods, processes and devices and systems finding application in the various embodiments described herein are not disclosed in detail. Persons having ordinary skill in the art will recognize that there may be many implementation-specific details that are not described here, but that would be considered part of a routine undertaking to implement the inventive concepts of the present invention.

Referring now to the drawings, embodiments of the present invention will be described. Several embodiments of the present invention are discussed below. The appended drawings illustrate only typical embodiments of the present invention and therefore are not to be considered limiting of its scope and breadth. In the drawings, some, but not all, possible embodiments are illustrated, and further may not be shown to scale.

The present invention offers methods and apparatus for seismic monitoring of hydrofracturing of target Stimulated Rock Volumes in situations where passive monitoring is difficult or impossible because of weak micro-seismic signals. The inventive concept optimally utilizes a number of steps in a novel and unanticipated synergistic combination. The inventive concept utilizes shear body waves which are known to be particularly sensitive to fracture density. Shear waves are utilized in near vertical directions for both up- and down-going paths which helps avoid many the deleterious complications associated with mode conversions and the free surface.

Vertical vibrators that are readily available are used in a manner that generates significant down-going shear wave seismic energy. Rotational geophones which are selectively sensitive to shear waves are used to enhance the desired shear wave data. Further, linear geophones may be used in some configurations, including in conjunction with rotational phones, to allow signal processing algorithms to further enhance the vertically up-going shear wave data.

The present invention offers multiple techniques to detect changes in fracturing within a targeted SRV. These include, but are not limited to: amplitude changes due to reflections involving layers with changes in fracture density; amplitude changes due to transmission through layers with changes in fracture density; and changes in fast and slow shear waves (Shear Wave Splitting) due to transmission through layers having changes in fracture density.

Described herein are methods and apparatus for near real-time monitoring of hydrofracturing.

Described herein are embodiments of methods and apparatus for particularly sensitive measurements of fracture density. The seismic sources and receivers are fixed in location, thus removing extraneous variations in amplitude and near surface velocities often experienced in conventional 4D seismic surveys. The use of nearly continuous Vibroseis signals allows the ability to statistically improve signals over minutes, tens of minutes, or longer as desired.

The primary indicators of the presence of hydro-fracturing within a target SRV are differential changes in Shear Wave Splitting time differences; and differential changes in seismic amplitudes. Such differential indicators can be calculated in their most fundamental form quickly and in a manner that does not require significant manual intervention. Further, such differential indicators do not require strong discrete reflections below the target SRV, nor require the ability to pick multiple parameters from data. Rather, in a most fundamental form, all that is needed is to detect changes in arrival times and/or changes in amplitudes in large time windows that are deeper than the target SRV.

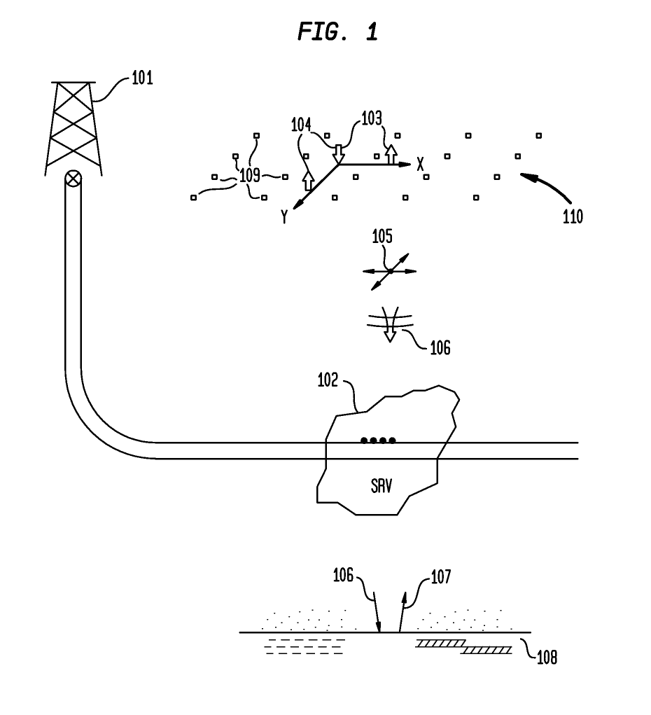

FIG. 1 depicts a diagrammatic example of a field configuration for recording data. Typically there will be one or more oil and/or gas wells 101 penetrating a target Stimulated Reservoir Volume (SRV) 102. Vibrators 103, 104 are utilized as an Active Seismic Source, with multiple dipole orientations. Shear seismic waves 105 are transmitted downwards 106. These waves may be reflected upwards 107 from a seismic reflector 108 below target SRV 102. This upward traveling seismic energy will be received at array 110 of recording sensors locations 109. The seismic data recorded at particular sensor location 109 may have traveled through SRV 102 on both its down-going and up-going propagation.

The array 110 of sensor locations 109 will typically be deployed on a more or less regular grid with typical spacing on the order of 50 meters or 100 meters. The sensors at sensor locations 109 may include both multi-component rotational seismic sensors and/or multi-component linear seismic sensors. These sensors may be on the surface of the earth, or be deployed at one or more depths in an array of shallow monitoring wells.

Each sensor location 109 will typically include up to three Cartesian linear motion sensors, up to three Cartesian rotational motion sensors; and may include pressure and pressure gradient measurement sensors.

The use of the present novel combination and deployment of rotational, linear, and pressure sensors allows for the separation of compressional (P) waves from shear (S) waves, as well as for the determination of direction for each wave. Such combination of sensors allows for many various signal processing algorithms to be employed.

A sensor that detects rotation, which is related to curl of displacement, will selectively detect shear waves.

In general, the pressure signal will be non-zero for compressional waves (when away from the free surface); and zero for shear waves.

In general, the rotational signals will be zero for compressional waves; and non-zero for shear waves.

In general, one or more of the components, u, v, w in the horizontal x, horizontal y, and vertical z directions, respectively, of the linear displacement vector will be non-zero for both compressional and shear waves.

Near-vertical up-going compressional waves will preferentially excite the vertical, w, linear component, but preferentially not the horizontal u, v, linear components. They will preferentially not excite any of the rotational components.

Near-vertical up-going shear waves will preferentially excite the horizontal u, v, linear components, but preferentially not the vertical linear component. They will preferentially excite the horizontal rotational components, but not the vertical rotational component.

Those skilled in the art will recognize that there may be many complications in the seismic signals measured on the surface, or within any particular shallow monitoring well. These complications can depend on many factors, including but not limited to variations in elastic parameters and density around sensor location 109, and how well the sensor is coupled to the earth. In the case of deployments in shallow holes, complicating factors include whether the shallow monitoring well is filled with air, brine, sand, gravel, cement, or other material. Additionally there may be other modes of seismic wave propagation detected, including but not limited to Rayleigh waves, and potentially other modes of wave. Persons having ordinary skill in the art will recognize that in the present invention, the detection of fracturing fundamentally depends only on differences in seismic arrival times and/or differences in amplitudes caused by fracturing at depths below near surface variations and noise. Due to its differential nature, the present invention is preferentially insensitive to these many complicating near surface factors.

The effect of the free surface is such as to typically cause the conversion between compressional waves and shear waves. This conversion effect complicates the ability to separate compressional waves and shear waves. Corrections for these effects can be utilized in data processing as described, for example, in Aki & Richards (2002), particularly pp. 184-185. However, these free surface corrections are dependent upon knowledge of near surface velocities and upon a relatively homogeneous nature for the near surface. This may not be a typical situation because it is commonly understood that near surface geology can be particularly variable. However, the present invention is fundamentally based on shear waves that travel predominantly in the vertical direction only, either down-going or up-going. Because the present invention is fundamentally based on fixed deployments of seismic sources and sensors, as well as based on near vertical wave propagation, it is preferentially less sensitive to the deleterious complicating factors of the near surface.

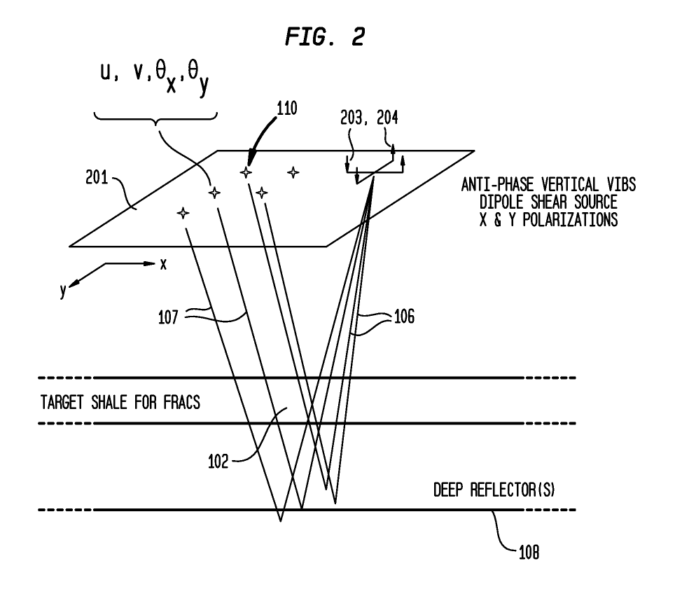

FIG. 2 depicts wavefield measurement concepts in one exemplary configuration of the present invention. Two vibrators, acting as dipole shear wave seismic sources 203, 204, are oriented orthogonally on the surface of the earth generally over the target zone of interest. Shear wave energy is propagated downward 106 through target SRV 102, reflected from deeper seismic reflectors 108, and propagated back upward 107. Array 110 of sensor locations 109 is deployed generally over the target zone of interest. Sensor measurements 201 for each sensor location 109 in array 110 include measurements of the x-horizontal linear motion, u; the y-horizontal linear motion, v; and rotational measurements around the two horizontal axes, x and y.

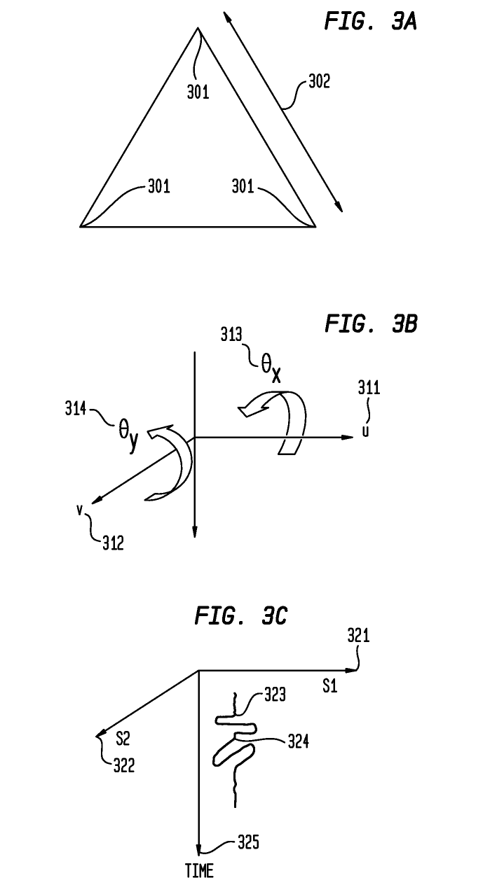

FIG. 3A depicts one exemplary deployment of vertical seismic vibrator sources in map view. Three vibrators are deployed at the vertices 301 of an equilateral triangle. Any combination of two of the vibrators forms a pair, thus there are three possible pairs of vibrators. Each of the three pairs of vibrators may be utilized in anti-phase drive configuration so as to create a dipole source of horizontally polarized downgoing shear waves. The three possible pairs of vibrators allow for generation of shear waves with three horizontal polarizations at 60 degree azimuthal increments.

The spacing 302 between vibrators is shown in FIG. 3A. In many embodiments of the present invention, spacing 302 is chosen to optimize the shear body wave energy transmitted in a generally downward direction. The choice of spacing is based on elastic parameters such as compressional body wave velocity, and shear body wave velocity, utilizing theories such as those described in “The field and radiation impedance of mechanical radiators on the free surface of a semi-infinite isotropic solid”, Miller, G. F. and Pursey, H., 1954, Proc. Royal Soc. London, A 223, 521-541 and “The elastodynamic field of N interacting vibrators (two-dimensional theory”, Tan, T. H., Geophysics, 1985, No. 8, p 1229-1252, for the interaction between vibrators.

FIG. 3B depicts the orientation and sign conventions in one exemplary configuration for each of the sensor locations 109. Horizontal linear components of motion are depicted as 311 and 312. Rotational motions around horizontal axes are depicted as 313 and 314.

FIG. 3C diagrammatically depicts Shear Wave Splitting at one sensor location 109 in the form of two wavelets in a time series 325 of multi-linear-component seismic data. In the horizontal direction 321 of the fast shear wave polarization, linear motion of wavelet 323 is seen arriving at an earlier time. In the horizontal direction 322 of the slow shear wave polarization, linear motion of a wavelet 324 is seen arriving at a later time. The wavelet shapes, phases, and time separations shown in FIG. 3C are diagrammatic only and will vary depending on many factors.

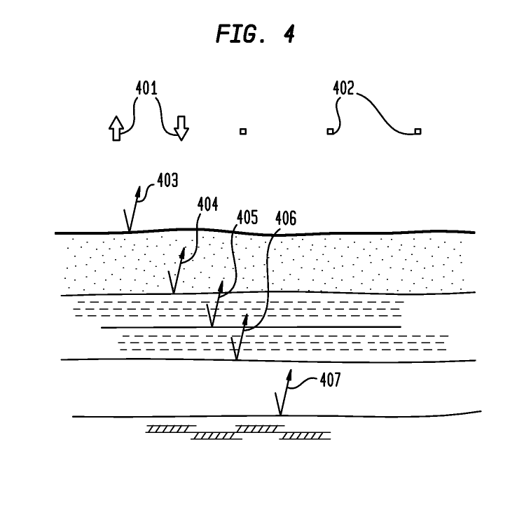

FIG. 4 is a cross section of the earth, depicting a dipole shear seismic wave source 401 and sensors 402 on the surface of the earth. Various seismic reflectors that may return energy to the surface of the earth in various aspects of the present invention are shown. Returned energy 403 is due to a seismic reflector above the top of a target SRV. Returned energy 404 is due to a seismic reflector at the top of a target SRV. Returned energy 405 is due to a seismic reflector within a target SRV. Returned energy 406 is due to a seismic reflector at the base of a target SRV. Returned energy 407 is due to a seismic reflector below the base of a target SRV.

In various aspects of the present invention, the downgoing seismic energy 106 and all the up-going seismic energy 403-407 that is utilized will be propagating in directions that are near vertical. Those skilled in the art will recognize the novelty of the concepts engendered in recording various combinations of rotational, linear, and pressure data in a deployment on the free surface of the earth or in an array of shallow monitoring wells wherein only vertical arriving shear wave energy is to be preferentially retained, enhanced, and utilized to detect changes in fracture density at depth.

When sensors are deployed in an array of shallow monitoring wells, there may also sometimes be additional advantages in lowering the seismic noise levels below those experienced at the free surface. Also, deployment in shallow monitoring wells below the water table allows for the more effective use of pressure sensors.

In the geometry of the inventive concept, shear waves will propagate up and down in a generally vertical direction, generally perpendicular to lithologic units and seismic reflectors which are generally disposed in a horizontal orientation. In such a geometry, it is well known that Shear Wave Splitting time differences are a good direct indicator of crack density for a Horizontal Transverse Isotropic (HTI) media such as typically anticipated in hydro-fracturing operations. See, for example, “Estimation of fracture parameters from reflection seismic data—Part I: HTI model due to a single fracture”, Bakulin, A., et. al., 2000, Geophysics, Vol. 65, p 1788-1802.

In some embodiments of the present invention, deployment of rotational, linear, and pressure sensors in shallow monitoring wells may be advantageously done with sensors at several depth levels. Deployment of sensors at multiple levels allows for additional processing of the data. For example, compressional vs. shear waves may be separated; and upgoing vs. downgoing waves may be separated by well known techniques such as those commonly commercially used in Vertical Seismic Profiles, or as described, for example, in U.S. Pat. No. 4,446,541 to Cowles, entitled “Rotational Geophone”

In some embodiments of the present invention, orthogonal rotational seismic sensors may be deployed in the field with orientations aligned generally to the fast S1 and slow S2 axes, to facilitate quick discrimination between the arrival time of S1 and S2 shear wave polarizations. Such oriented deployments may be based on prior estimates of the likely S1 and S2 azimuths.

In some embodiments, analysis may be done in advance of a hydro-fracturing operation to determine the anticipated likely S1 and S2 fast and slow shear wave azimuths. Such analysis may be done by reference to pre-existing regional stress fields, by use of pre-existing knowledge of fracture sets, or by analysis of Shear Wave Splitting data acquired before the start of hydro-fracturing. By restricting the range of interest to specific azimuths for S1 and S2, the near real-time analysis during the hydro-fracturing operation may be made faster and simpler.

In some embodiments of the present invention, three vertical seismic source vibrators may be deployed in an equilateral triangle so as to enable three dipole shear seismic sources with azimuthal orientations spaced by 60 degrees. Such embodiments will use successive pairs of vibrators selected from the three in a sequenced manner. The two vibrators utilized for any given dipole will use anti-phase sweeps. Said sweeps may have their frequency bandwidths chosen to particularly enhance shear wave signals.

In some embodiments, more than three vibrators may be deployed in various geometries such as to allow two or more independently oriented dipole arrangements by selecting any two vibrators are for use. In other embodiments, a pair of vibrators may be used in a manner such that they are physically re-deployed between different dipole azimuth orientations.

In some embodiments, individual vertical seismic vibrators, and multi-component linear and/or rotational seismic sensors are deployed to enable Amplitude Vs. Azimuth (AVA) analysis of a target SRV. Vibrators and sensors may be placed at locations generally diametrically opposite each other, symmetrically disposed about the surface location directly above the target subsurface rock volume. Horizontal offset distances between seismic sources and sensors may be chosen based on modeling of Amplitude Vs. Offset and Azimuth effects, and chosen to preferentially be those offsets that are most sensitive to the presence/absence of generally vertically oriented fractures having particular azimuths within the target sub-surface rock volume. Said seismic sources and sensors may be disposed at one, or preferably several azimuths around the surface location directly above the target subsurface rock volume.

In some of these said embodiments, the shear body wave SV radiation lobe for a vertical seismic vibrator on the surface of the earth may be utilized for preferential shear-shear (S-S) AVO effects. In some embodiments vibrators and sensors may be disposed at azimuths aligned along pre-estimated S1 and S2 fast and slow shear wave polarization axes.

In some embodiments, the operation of the active seismic shear wave sources shall be continued for a period of several minutes or longer so as to obtain adequate signal to noise. Then the active sources shall not be operated for a period of time so as to allow some passive micro-seismic monitoring. Typically there shall be two, three, or more periods of operation of the active seismic shear wave sources during hydro-fracturing operations for any one stage.

In some embodiments, two horizontal axes of rotational data and two horizontal axes of linear motion data may be utilized.

In some embodiments, three axes (horizontal and vertical) of rotational data and three axes (horizontal and vertical) of linear motion data may be utilized. In those embodiments where the vertical axis of linear and/or rotational data are utilized, they may be used in signal processing targeted to removal of interfering seismic modes such as compressional waves or seismic energy from arrival directions not of interest.

In some embodiments, only rotational data may be used to detect and analyze shear wave data.

In some embodiments, only linear particle motion data may be used to detect and analyze shear wave data.

In some embodiments, pressure data may be used in conjunction with linear and/or rotational data. Such pressure (hydrophone) data may be utilized in signal processing to detect and attempt to remove the interfering effects of any compressional wave energy.

In some embodiments, sensors may be deployed in a Permanent Reservoir Monitoring (PRM) configuration which may include arrays of surface sensors and/or arrays of sensors in shallow holes.

In some aspects of the present invention, changes in amplitudes polarized along various horizontal axes are monitored. The amplitude changes may represent two-way transmission through a target SRV to a deeper reflector. Along the linear polarization axis normal to a fracture set, it is anticipated that there will be increased amplitude attenuation as the fracture density increases.

In some aspects of the present invention, changes in amplitudes polarized along various horizontal axes are monitored. The amplitude changes may represent reflections from the top, bottom, or internally within the SRV. Reflection amplitude changes for shear waves linearly polarized generally perpendicular to a reflector involving a layer with oriented fractures will represent changes in fracturing.

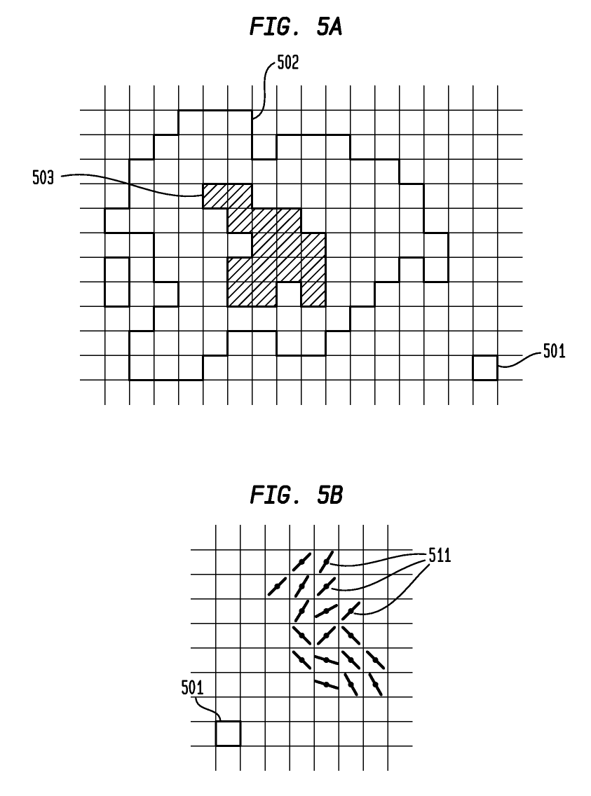

FIG. 5A is an exemplary illustration of a map view of a target SRV. This example depicts varying amounts of change in Shear Wave Splitting delta-time, before and after hydro-fracturing, in each of the subsurface bins represented by the sensor locations 109. For example within the boundary 502 there may be 4 msec. or more change in differential time shift; and within boundary 503 there may be 8 msec. of change in differential time shift due to shear wave splitting caused by hydro-fracturing. Such displays typically would have one bin 501 for each location within array 110. Bins 501 may typically have horizontal dimensions on the order of 25 meters. Such a display may represent a single layer within the target SRV, or may represent the full vertical extent of the target SRV. Those with skill in the art will recognize that many possible attributes may be displayed.

In some embodiments, a relatively simple and straightforward processing workflow may be utilized to analyze the amount of Shear Wave Splitting in terms of differential time shifts. Attention is focused on, for example, a series of time windows of several hundred msec. total duration before and after the two-way shear reflection time of the target SRV, first using a baseline data set from the beginning of the hydro-fracturing operation. Techniques such as Alford numerical rotation may be employed, possibly utilizing various time sub-windows, using the several source azimuthal orientations and the several horizontal components of rotational and/or horizontal components of linear sensors. This will allow a determination of the azimuths of the S1 and S2 fast and slow shear axes. Further, the Shear Wave Splitting is calculated above and below the SRV to yield an indication of any change in SWS due to the SRV.

Datasets from one or more subsequent times during hydro-fracturing may be processed by using the same indicated numerical rotation operations. Then time shifts representative of changes in the Shear Wave Splitting delta-time may be determined by techniques such as correlation. Additionally, a new determination of the azimuths of the S1 and S2 axes may be undertaken to analyze any changes in these azimuths due to hydro-fracturing operations.

In some embodiments, a baseline dataset may be acquired at or before the time of the start of the hydro-fracturing operation. One or more subsequent datasets may be the focus of interest, particularly at or near the time when pumping is ended, or before the beginning of flow-back, when the maximum volume has been pumped into the target SRV. Another subsequent dataset that may be the focus of interest is at or near the time of the end of flow-back. Differential calculations may be done relative to the initial baseline data set, or between any subsequent monitor data sets.

FIG. 5B illustrates one of many possible alternate displays. In this example the azimuthal orientation 511 of the fast S1 shear velocity axis is depicted. The length of bars may be used to depict the amount of differential time shift. Colors may also be used for attributes such as relative power. Each bin 501 represents the data from one of the sensor locations 109.

In many embodiments of the present invention, persons having ordinary skill in the art will recognize that processing of the acquired data may be undertaken in multiple forms. All prior art in signal processing and wavefield processing of seismic data may be utilized as necessary to enhanced desired signals. For example, those skilled in the art will appreciate that signal to noise enhancement processes such as deconvolution, filtering, and imaging in many aspects may be deployed.

A limited number of embodiments have been described herein. Those skilled in the art will recognize other embodiments within the scope of the claims of the present invention.

It is noted that many of the structures, materials, and acts recited herein can be recited as means for performing a function or step for performing a function. Therefore, it should be understood that such language is entitled to cover all such structures, materials, or acts disclosed within this specification and their equivalents, including any matter incorporated by reference.

It is thought that the apparatuses and methods of embodiments described herein will be understood from this specification. While the above description is a complete description of specific embodiments, the above description should not be taken as limiting the scope of the patent as defined by the claims.

Other aspects, advantages, and modifications will be apparent to those of ordinary skill in the art to which the claims pertain. The elements and use of the above-described embodiments can be rearranged and combined in manners other than specifically described above, with any and all permutations within the scope of the disclosure.

Although the above description includes many specific examples, they should not be construed as limiting the scope of the method, but rather as merely providing illustrations of some of the many possible embodiments of this method. The scope of the method should be determined by the appended claims and their legal equivalents, and not by the examples given.

What is claimed is:

1. A method for detecting fractures in near real-time during the pumping of a hydrofracture operation in an oil and gas reservoir, comprising:
(a) repeatedly emitting seismic shear waves in a generally downward direction in two or more polarizations, at one or more locations on the surface of the earth;
(b) recording data reflected from below an array of seismic sensors, and
(c) analyzing the recorded data to detect fast and slow shear waves at the seismic sensors, and to detect changes in the seismic arrival times during the general duration of the hydrofracture operations, or longer, so as to detect changes in fracturing within the Stimulated Rock Volume of the oil and gas reservoir.

2. The method of claim 1 wherein the seismic sensors include multi-component linear and multi-component rotational sensors.

3. The method of claim 1 wherein the seismic sensors include only rotational multi-component seismic sensors.

4. The method of claim 1 wherein the seismic sensors include only linear multi-component seismic sensors.

5. The method of claim 1 wherein three vertical Vibroseis units are deployed in an equilateral triangle configuration, and wherein 400 or more sensor locations are deployed on the surface of the earth with spacings between 25 meters and 200 meters.

6. The method of claim 1 wherein seismic sensors are deployed in a permanent configuration on the surface of the earth and/or in an array of shallow wells.

7. The method of claim 1 wherein the data are processed in a laboratory or office setting at a time subsequent to the field acquisition of data.

8. The method of claim 1 wherein impulsive seismic sources are used in place of seismic vibrators.

9. The method of claim 1 wherein active seismic source fracture monitoring is time interleaved with passive seismic monitoring, during the duration of the hydro-fracturing operation for one or more stages.

10. An apparatus for detecting fractures in near real-time during the pumping of a hydrofracture operation in an oil and gas reservoir, comprising:
(a) an apparatus to emit seismic shear waves in a generally downward direction in two or more polarizations, at one or more locations on the surface of the earth;
(b) an apparatus to measure and record data reflected from below an array of seismic sensors and
(c) an apparatus to analyze the recorded data to detect fast and slow shear waves at the seismic sensors, and to detect changes in the seismic arrival times during the general duration of the hydrofracture operations or longer so as to detect changes in fracturing within the Stimulated Rock Volume of the oil and gas reservoir.

11. The method of claim 10 wherein the seismic sensors include multi-component linear and multi-component rotational sensors.

12. The method of claim 10 wherein the seismic sensors include only rotational multi-component seismic sensors.

13. The method of claim 10 wherein the seismic sensors include only linear multi-component seismic sensors.

14. The apparatus of claim 10 wherein three vertical Vibroseis units are deployed in an equilateral triangle configuration, and wherein 400 or more sensor locations are deployed on the surface of the earth with spacings between 25 meters and 200 meters.

15. The apparatus of claim 10 wherein seismic sensors are deployed in a permanent configuration on the surface of the earth and/or in an array of shallow wells.

16. The apparatus of claim 10 wherein the data are processed in a laboratory or office setting at a time subsequent to the field acquisition of data.

17. The apparatus of claim 10 wherein impulsive seismic sources are used in place of seismic vibrators.

18. The apparatus of claim 10 wherein active seismic source fracture monitoring is time interleaved with passive seismic monitoring, during the duration of the hydro-fracturing operation for one or more stages.

19. A geophysical system to detect changes in fractures in near real-time during the pumping of a hydrofracture operation in a potential oil and gas reservoir, comprising:
(a) a sub-system to repeatedly emit seismic shear waves in a generally downward direction in two or more polarizations, in one or more locations on the surface of the earth;
(b) a sub-system of multi-component linear sensors, multi-component rotational sensors, or both multi-component linear sensors and multi-component rotational sensors, and a system to record data reflected from below the array of seismic sensors and
(c) a sub-system to analyze the recorded data to detect fast and slow shear waves at the seismic sensors, and to detect changes in the seismic arrival times during the general duration of the hydrofracture operations, or longer, so as to detect changes in fracture density within the Stimulated Rock Volume of the oil and gas reservoir.
